(19) United States
(12) Patent Application Publication
(10) Pub. No.: US 2020/0291329 A1
(43) Pub. Date: Sep. 17, 2020

(54) CLEANING PRODUCT

(71) Applicant: The Procter & Gamble Company, Cincinnati, OH (US)

(72) Inventors: Denis Alfred GONZALES, Brussels (BE); Aicha DKIDAK, Brussels (BE); Patrick Firmin August DELPLANCKE, Steenhuize-Wijnhuize (BE); Robby Renilde Francois KEULEERS, LIPPELO (SINT AMANDS) (BE)

(21) Appl. No.: 16/891,888

(22) Filed: Jun. 3, 2020

Related U.S. Application Data
(63) Continuation of application No. 15/872,096, filed on Jan. 16, 2018, now abandoned.

(30) Foreign Application Priority Data
Jan. 16, 2017 (EP) 17151672.7

(51) Int. Cl. C11D 3/20; C11D 17/04; A47L 17/00; C11D 1/825; C11D 3/04; C11D 3/10; C11D 3/30; C11D 11/00

(52) U.S. Cl. CPC C11D 3/2093; C11D 17/041; A47L 17/00; C11D 1/825; C11D 3/046; C11D 1/72; C11D 3/201; C11D 3/2044; C11D 3/30; C11D 11/0023; C11D 11/0064; C11D 3/10

(57) ABSTRACT

A cleaning product having a spray dispenser and a cleaning composition suitable for spraying and foaming, the composition is housed in the spray dispenser and the composition includes: i) from about 5 to about 15% by weight of the composition of a surfactant system; and ii) from about 0.1 to about 15% by weight of the composition of an specific ester.

### FIELD OF INVENTION

The present invention relates to a cleaning product. In particular, it relates to a cleaning product comprising a spray dispenser and a cleaning composition. The product makes the cleaning of dishware easier and faster.

### BACKGROUND OF THE INVENTION

Traditionally manual dishwashing has been performed by filling a sink with water, adding a dishwashing detergent to create a soapy solution, immersing the soiled articles in the solution, scrubbing the articles and rinsing to remove the remaining soils and remove the suds generated from the soapy solution from the washed articles. Traditionally an entire load of soiled dishware has usually been washed in one go. Nowadays some users prefer to clean articles as soon as they have finished with them rather than wait until they have a full load. This involves washing a single article or a small number of articles at the time. The washing is usually performed under running water rather than in a full sink. The cleaning should be fast and involve minimum effort from the user.

Nowadays, a high number of users prefer to do the washing under the tap. This usually involves the use of a cleaning implement, such as a sponge. The user delivers detergent to the sponge. When the number of items to be cleaned is small, there is the risk of dosing more detergent than required, this will require the need for more rinsing for the dishware and the cleaning implement. Another disadvantage associated to this method, is that sometimes is required to mix the detergent with water in the sponge, this can slow down the cleaning process.

The level and type of soil found on dishware varies considerably depending on the use of the dishware. Dishware can be lightly soiled or can have hard to remove soils such as baked-, cooked- and/or burnt-on soils. It might be easier to design different products for different types/degrees of soils however this might not be very practical because the user would have to have a large number of dishwashing products.

When the cleaning of a lightly soiled article is done under running water, it is desirable that the cleaning is performed quickly and with minimum effort. Ideally, the product should be applied and then immediately rinsed obviating or reducing the need for scrubbing.

When articles are soiled with difficult to remove soils, it is desirable that the product facilitates the cleaning task by softening the well-attached soils. It is desirable that the softening takes place in a short time. In cases in which the soils are really tough it is common practice to soak the items before cleaning. The soaking time should be short.

Spray products are well liked by users. A sprayable composition for use in hand dishwashing should be easy to spray, deliver fast and long lasting suds, easy to rinse and at the same time should provide fast and good cleaning of a variety of soils. The composition should be such that when sprayed onto the dishware spreading to the surrounding atmosphere should be minimised or avoided. Spreading to the surrounding atmosphere can not only give rise to waste of the product but it can also have inhalation risks associated to it.

The object of the present invention is to facilitate cleaning, especially the manual dishwashing task, in particular by reducing the time and effort needed to achieve the cleaning.

### SUMMARY OF THE INVENTION

According to a first aspect of the invention, there is provided a cleaning product. The product is suitable for the cleaning of any kind of surfaces but preferably the product is a hand dishwashing cleaning product. The product comprises a spray dispenser and a cleaning composition. The composition is a foaming composition and it is suitable for spraying. The composition is housed in the spray dispenser. The “composition” of the cleaning product of the invention is herein sometimes referred to as “the composition of the invention”.

By “spray dispenser” is herein meant a container comprising a housing to accommodate the composition and means to spray that composition. The preferred spraying means being a trigger spray. The composition foams when it is sprayed. Foaming is a property that users associate with cleaning therefore it is important that the composition of the invention foams to send the user the signal that the composition is cleaning.

The composition of the invention comprises:
i) from about 5 to about 15% by weight of the composition of a surfactant system; and
ii) from about 0.1 to about 15% by weight of the composition of an ester selected from the group consisting of :
   a) monoesters having the formula R1C═OOR2 wherein:
   R1 is a linear of branched C1 to C4 alkyl;
   R2 is a linear or branched C2 to C8 alkyl;
   b) di- or tri-esters having the formula R1(C═OOR2)n wherein:
   R1 is a saturated or unsaturated C2 to C4 alkyl;
   R2 is independently selected from a linear or branched C2 to C8 alkyl;
   n is 2 or 3;
   c) benzylbenzoate; and
   d) mixtures thereof.

Preferably, the composition comprises:
i) from about 5 to about 15% by weight of the composition of a surfactant system; and
ii) from about 0.1 to about 15% by weight of the composition of an ester selected from the group consisting of:
   a) monoesters having the formula R1C═OOR2 wherein:
      R1 is a linear of branched C2 or C3 alkyl;
      R2 is a linear or branched C3 or C4 alkyl;
   b) di- or tri-esters having the formula R1(C═OOR2)n wherein:
      R1 is a saturated or unsaturated C2 to C4 alkyl;
      R2 is independently selected from a linear or branched C3 or C4 alkyl;
      n is 2;
   c) benzylbenzoate; and
   d) mixtures thereof.

The compositions of the invention provide very good and fast cleaning and it helps with the foaming of the product.

Preferably, the surfactant system and the ester are in a weight ratio of from about 5:1 to about 1:5, preferably from 3:1 to 1:2, most preferably 2:1 to 1:1. The surfactant system seems to help with the cleaning and foam generation. The ester helps with the speed of cleaning and with foam generation and stabilization.

Furthermore, the composition of the invention provides good cleaning, including cleaning of though food soils such as cooked-, baked- and burnt-on soils and good cleaning of light oily soils. The composition of the invention not only provides outstanding cleaning but also very fast cleaning, requiring reduced scrubbing effort by the consumer. Thus the product of the invention is especially suitable for cleaning dishware under the tap. When the dishware is only lightly soiled the composition of the invention provides very good cleaning with reduced scrubbing or in the absence of scrubbing. The dishware can be cleaned by simply spraying the composition followed by a rinse with water, optionally aided by a low force wiping action.

In the case of heavily soiled dishware the product of the invention is very good to facilitate the removal of the soil when the product is used to pre-treat the dishware. Pre-treatment usually involves leaving the soiled dishware with the neat product.

Preferably, the composition of the invention has a pH greater than 5 as measured at 10% solution in distilled water at 20° C. Compositions having a pH from6 to 8, present good chemical stability. Compositions having a pH from 8 to 12, most preferably from 10.5 to 11.5 provide very good grease cleaning.

Preferably, the composition of the invention has a pH from 8 to 12, the composition has a reserve alkalinity of from about 0.1 to about 1, more preferably from about 0.1 to about 0.5. Reserve alkalinity is herein expressed as grams of NaOH/100 ml of composition required to titrate product from a pH 10 to the pH of the finished composition. This pH and reserve alkalinity further contribute to the cleaning of tough food soils.

Compositions having a surfactant system comprising an anionic surfactant and at least one further surfactant have been found to be very good from a cleaning and sudsing viewpoint. They have also been found very good from a spray pattern view point. The presence of small droplets (and therefore the risk of inhalation) is minimized when the surfactant system of the composition of the invention comprises anionic surfactant. By “further surfactant” is herein meant a surfactant that is not an anionic surfactant or a non-ionic surfactant. Preferably the anionic surfactant is a sulfate surfactant or an alkyl sulfosuccinate. Preferred sulfate surfactants are an alkyl ethoxylate sulfate or a branched short chain alkyl sulfate. It has been found that alkyl ethoxylated sulfate with an average degree of ethoxylation from about 2 to about 4, more preferably about 3, performs better in terms of cleaning and speed of cleaning than other ethoxylate alkyl sulfate surfactants with a lower degree of ethoxylation.

By a “branched short chain alkyl sulfate” is herein meant a surfactant having a linear alkyl sulfate backbone, the backbone comprising from 4 to 8, preferably from 5 to 7 carbon atoms, substituted with one or more C1-C5 preferably C1-C3 alkyl branching groups in the C1, C2 or C3, preferably C2 position on the linear alkyl sulfate backbone. This type of anionic surfactant has been found to deliver strong grease cleaning as well as good foaming performance, especially immediate foaming performance upon spraying when the composition comprises amine oxide or betaine, preferably amine oxide as co-surfactant. Preferred branched short chain alkyl sulfate for use herein is a branched hexyl sulfate, more preferably 2-ethyl hexyl sulfate. The preferred alkyl sulfosuccinate herein is 2-ethylhexylsulfosuccinate.

Preferably, the at least one further surfactant is selected from the group consisting of betaine preferably cocoamidopropylbetaine, sulfobetaine preferably laurylhydroxysulfobetaine, amine oxide preferably C12-14 alkyldimethylamine oxide, and mixtures thereof. Amine oxide is the preferred further surfactant for use herein. The at least one further surfactant seems to help with the sudsing of the product. Particularly good performing products are those in which the anionic surfactant and the at least one further surfactant are present in a weight ratio of about 5:1 to about 1:5 preferably of about 3:1 to about 1:1, most preferably in a weight ratio from about 2:1 to about 1:1. When the anionic surfactant comprises an alkoxylated alkyl sulphate the preferred anionic surfactant:further surfactant weight ratio is from 3:1 to 2:1. When the anionic surfactant comprises a short chain branched alkyl sulphate surfactant the preferred anionic surfactant:further surfactant weight ratio is from 2:1 to 1:1. Especially preferred are compositions in which the further surfactant comprises amine oxide. The surfactant system can optionally further comprise a non-ionic surfactant, preferably selected from ethoxylated alcohols and alkyl glycerol ethers.

The composition of the invention can comprise glycol ethers selected from the group consisting of glycol ethers of Formula I: R1O(R2O)nR3, Formula II: R4O(R5O)nR6 and mixtures thereof wherein R1 is a linear or branched C4, C5 or C6 alkyl or a substituted or unsubstituted phenyl, R2 is ethyl or isopropyl, R3 is hydrogen or methyl and n is 1, 2 or 3, R4 is n-propyl or isopropyl, R5 is isopropyl, R6 is hydrogen or methyl and n is 1, 2 or 3 and mixtures thereof. It has been found that these glycol ethers further help not only with the speed of cleaning of the product but also with the cleaning, especially greasy soils cleaning. This does not seem to happen with glycol ethers having a different formula to Formula I and Formula II.

The composition of the invention can comprise an alcohol selected from the group consisting of: C4-C6 linear mono-alcohols, branched C4-C10 mono-alcohols having one or more C1-C4 branching groups, alkyl mono-glycerols, and mixtures thereof. The compositions of the invention comprising these alcohols provide very good and fast cleaning and it helps with the foaming of the product.

Mixtures of an alcohol, in particular a C4-C8 branched primary mono-alcohol with a glycol ether of Formula I: R1O(R2O)nR3, Formula II: R4O(R5O)nR6 or mixtures thereof wherein R1 is a linear or branched C4, C5 or C6 alkyl or a substituted or unsubstituted phenyl, R2 is ethyl or isopropyl, R3 is hydrogen or methyl and n is 1, 2 or 3, R4 is n-propyl or isopropyl, R5 is isopropyl, R6 is hydrogen or methyl and n is 1, 2 or 3 have also been found to provide an unexpected good cleaning and speed of cleaning. In particular mixtures with ethylhexanol especially 2-ethyl-1-hexanol, propylhexanol especially 2-propyl-1-heptanol, and methyl hexanol, in particular trimethyl hexanol especially 3,5,5 trimethyl-1-hexanol, have been found particularly good when they are part of a mixture, in terms of cleaning and speed of cleaning, especially mixtures of these alcohols with propyleneglycol n-butyl ether, dipropyleneglycol n-butyl ether, and mixtures thereof, especially dipropyleneglycol n-butyl ether.

The composition of the invention can further comprise an alcohol solvent selected from the group consisting of C1-C3 linear of branched mono alcohols, C1-C3 polyols and mixtures thereof, a glycol solvent selected from the group consisting of ethyleneglycol, propyleneglycol, polyethyleneglycol, polypropyleneglycol, and mixtures thereof, and/or a hydrotrope selected from the group consisting of sodium cumene sulphonate, sodium xylene sulphonate, sodium toluene sulphonate, and mixtures thereof. These short chain alcohols, polyols, glycols and hydrotropes are found to help physically stabilizing the formulation.

The composition of the invention can comprise a cyclic diamine of Formula(I):

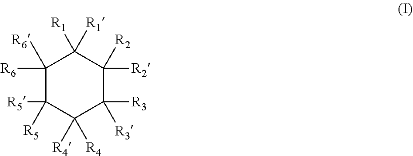

wherein two of the Rs, are selected from the group consisting of NH2, (C1-C4)NH2 and mixtures thereof and the remaining Rs are independently selected from H, linear or branched alkyl or alkenyl having from 1 to 10 carbon atoms.

The composition of the invention can comprise cleaning amines such as polyetheramines selected from the group consisting of polyetheramines of Formula (I), Formula (II), Formula (III) and a mixture thereof:

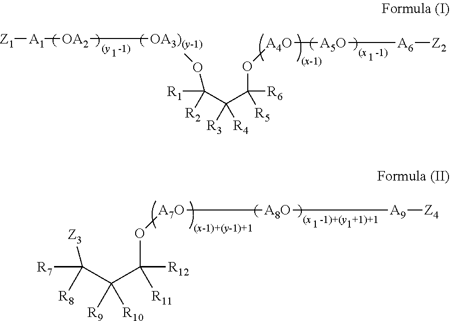

wherein each of R₁-R₁₂ is independently selected from H, alkyl, cycloalkyl, aryl, alkylaryl, or arylalkyl, wherein at least one of R₁-R₆ and at least one of R₇-R₁₂ is different from H, each of A₁-A₉ is independently selected from linear or branched alkylenes having 2 to 18 carbon atoms, each of Z₁-Z₄ is independently selected from OH or NH₂, wherein at least one of Z₁-Z₂ and at least one of Z₃-Z₄ is NH₂, wherein the sum of x+y is in the range of about 2 to about 200, wherein x≥1 and y≥1, and the sum of x₁+y₁ is in the range of about 2 to about 200, wherein x₁≥1 and y₁≥1.

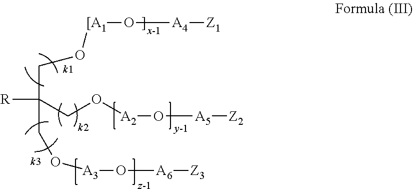

wherein
R is selected from H or a C1-C6 alkyl group, each of k₁, k₂, and k₃ is independently selected from 0, 1, 2, 3, 4, 5, or 6, each of A₁, A₂, A₃, A₄, A₅, and A₆ is independently selected from a linear or branched alkylene group having from about 2 to about 18 carbon atoms or mixtures thereof, x≥1, y≥1, and z≥1, and the sum of x+y+z is in the range of from about 3 to about 100, each of Z₁, Z₂, and Z₃ is independently selected from NH₂ or OH, where at least two of Z₁, Z₂, and Z₃ are NH₂, and the polyetheramine has a weight average molecular weight of from about 150 to about 1000 grams/mole.

Other preferred amines for use herein are amines of Formula (1):

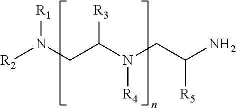

wherein: R₁, R₂, R₃, R₄, and R₅ are independently selected from —-H, linear, branched or cyclic alkyl or alkenyl having from 1 to 10 carbon atoms and n=0-3.

### or Formula (2):

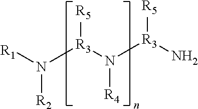

wherein R₁ and R₄ are independently selected from —H, linear, branched or cyclic alkyl or alkenyl; and R2 is a linear, branched or cyclic alkyl or alkenyl having from 3 to 10 carbons, R₃ is a linear or branched alkyl from 3 to 6 carbon atoms, R₅ is H, methyl or ethyl and n=0-3.
or the amine of Formula (3)

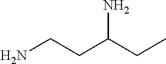

and mixtures thereof.

Preferred cyclic diamines for use herein include 1,3-bis (aminomethyl) cyclohexane (1,3-BAC), 2-methylcyclohexane-1,3-diamine, 4-methylcyclohexane-1,3-diamine and mixtures thereof. Compositions comprising 1,3-BAC, 2-methylcyclohexane-1,3-diamine, 4-methylcyclohexane-1,3-diamine and mixtures thereof, provide very good grease removal from dishware and the dishware does not feel slippery during rinse. Especially preferred are composition comprising 2-methylcyclohexane-1,3-diamine, 4-methylcyclohexane-1,3-diamine and mixtures thereof.

Preferably, the composition of the invention further comprises a chelant, preferably an aminocarboxylate chelant, more preferably GLDA. The aminocarboxylate not only act as a chelant but also contributes to the reserve alkalinity, this seems to help with the cleaning of cooked-, baked- and burnt-on soils. Preferably, the composition of the invention comprises bicarbonate and/or monoethanol and/or carboxylate builder preferably citrate builder, that as in the case of the of the aminocarboxylate chelant also contribute to the reserve alkalinity.

The composition of the invention can be Newtonian or non-Newtonian. Preferably the composition is a shear thinning fluid. This is important to allow the composition to be easily sprayed. The viscosity of the composition of the invention should also make the fluid to stay in vertical surfaces to provide cleaning and at the same time be easy to rinse. Especially suitable have been found compositions having a starting viscosity at high shear (10,000 s-1) of from about 1 to about 10 mPa s. Preferably, the composition is a shear thinning composition having a low shear (100 s-1) to high shear (10,000 s-1) viscosity ratio of from about 10:1 to about 1.5:1 at 20° C. as measured using the method defined herein below. Preferably the composition of the invention comprises a rheology modifier, more preferably xanthan gum.

A preferred composition has a pH of from 6 to 8 or from 10 to 11.5 as measured in a 10% solution in distilled water at 20° C., if the composition has a pH from 10 to 11.5 the reserve alkalinity is from 0.1 to 0.3 expressed as g NAOH/100 ml of composition at a pH of 10, the composition comprises:
i) from about 4 to about 10%, preferably from about 5 to about 8% by weight of the composition of an alkyl ethoxylate sulfate, preferably the alkyl ethoxylate sulfate having an average degree of ethoxylation of about 3;
ii) from about 1 to about 5% by weight of the composition of amine oxide surfactant;
iii) from about 3% to about 8%, preferably from about 4 to about 7% by weight of the composition of the ester; and optionally
iv) from about 1% to about 8%, preferably from about 2 to about 7% by weight of the composition of a glycol ether solvent, preferably dipropylene glycol n-butyl ether, or an alcohol selected from the group consisting of: C4-C6 linear mono-alcohols, branched C4-C10 mono-alcohols having one or more C1-C4 branching groups, alkyl mono-glycerols, and mixtures thereof.

A preferred composition has a pH of from 6 to 8 or from 10 to 11.5 as measured in a 10% solution in distilled water at 20° C., if the composition has a pH from 10 to 11.5 the reserve alkalinity is from 0.1 to 0.3 expressed as g NAOH/100 ml of composition at a pH of 10, the composition comprising:
i) from about 4 to about 10%, preferably from about 5 to about 8% by weight of the composition of an alkyl ethoxylate sulfate, preferably the alkyl ethoxylate sulfate having an average degree of ethoxylation of about 3;
ii) from about 1 to about 5% by weight of the composition of amine oxide surfactant;
iii) from about 3% to about 8%, preferably from about 4 to about 7% by weight of the composition of the ester; and optionally
iv) from about 0.1% to from about 2%, preferably from about 0.2 to about 1% by weight of the composition of the amine, preferably a cyclic diamine preferably selected from the group consisting of 2-methylcyclohexane-1,3-diamine, 4-methylcyclohexane-1,3-diamine and mixtures thereof; and optionally
v) from about 3% to about 8%, preferably from about 4 to about 7% by weight of the composition of a glycol ether of Formula I, formula II, or an alcohol selected from the group consisting of: C4-C6 linear mono-alcohols, branched C4-C10 mono-alcohols having one or more C1-C4 branching groups, alkyl mono-glycerols, and mixtures thereof, or mixtures thereof.

Another preferred composition has a pH of from 6 to 8 or from 10 to 11.5 as measured in a 10% solution in distilled water at 20° C., if the composition has a pH from 10 to 11.5 the reserve alkalinity is from 0.1 to 0.3 expressed as g NAOH/100 ml of composition at a pH of 10, the composition comprising:
i) from about 4 to about 10%, from about 5 to about 8% by weight of the composition of a branched short chain sulfate, preferably 2-ethyl hexyl sulfate,
ii) from about 1 to 5% by weight of the composition of amine oxide surfactant; and
iii) from about 3% to about 8%, preferably from about 4 to about 7% by weight of the composition of the ester; and optionally
iv) from about 0.1% to from about 2%, preferably from about 0.2 to about 1% by weight of the composition of the amine, preferably a cyclic diamine selected from the group consisting of 2-methylcyclohexane-1,3-diamine, 4-methylcyclohexane-1,3-diamine and mixtures thereof; and optionally
v) from about 3% to about 8%, preferably from about 4 to about 7% by weight of the composition of an glycol ether of Formula I, formula II, an alcohol selected from the group consisting of: C4-C6 linear mono-alcohols, branched C4-C10 mono-alcohols having one or more C1-C4 branching groups, alkyl mono-glycerols, and mixtures thereof, or mixtures thereof.

According to the second aspect of the invention, there is provided a method of cleaning soiled dishware using the product according to any of the preceding claims comprising the steps of:
a) optionally pre-wetting the soiled dishware
b) spraying the cleaning composition onto the soiled dishware;
c) optionally adding water to the soiled dishware during a period of time;
d) optionally scrubbing the dishware; and
e) rinsing the dishware.

The method of the invention allows for faster and easier cleaning of dishware under running tap, especially when the dishware is lightly soiled. When the dishware is soiled with tough food soils such as cooked-, baked- or burnt-on soils the method of the invention facilitates the cleaning when the soiled dishware is soaked with the product of the invention in neat form or diluted in water.

### DETAILED DESCRIPTION OF THE INVENTION

The present invention envisages a cleaning product, preferably a hand dishwashing cleaning product, the product comprises a spray dispenser and a cleaning composition. The cleaning composition comprises a surfactant system, a specific ester and optionally a specific glycol ether solvent, a specific alcohol solvent and/or a specific amine solvent. The product of the invention simplifies the cleaning task, in particular the manual cleaning task, by making the task easier and faster. The product of the invention is particularly suitable for the manual cleaning of dishware.

For the purpose of the present invention “dishware” encompasses all the items used to either cook or used to serve and eat food.

### Cleaning Composition

The cleaning composition is preferably a hand dishwashing cleaning composition, preferably in liquid form.

Preferably the pH of the composition is greater than 5, preferably from 6 to 8, or from 8 to 12, preferably from 10.5 to 11.5, as measured at 20° C. and 10% concentration in distilled water. If the composition has a pH from 8 to 12, preferably from 10.5 to 11.5 then the composition preferably has a reserve alkalinity of from about 0.1 to about 1, more preferably from about 0.1 to about 0.5 measured as detailed herein below.

Reserve alkalinity is defined as the grams of NaOH per 100 g of composition required to titrate the test composition at pH 10 to come to the test composition pH. The reserve alkalinity for a solution is determined in the following manner.

A pH meter (for example An Orion Model 720A) with an Ag/AgCl electrode (for example an Orion sure flow Electrode model 9172BN) is calibrated using standardized pH 7 and pH 10 buffers. A 100 g of a 10% solution in distilled water at 20° C. of the composition to be tested is prepared. The pH of the 10% solution is measured and the 100 g solution is titrated down to pH 10 using a standardized solution of 0.1 N of HCl. The volume of 0.1N HCl required is recorded in ml. The reserve alkalinity is calculated as follows:

Reserve Alkalinity=ml 0.1N HCl×0.1 (equivalent/liter)×Equivalent weight NaOH (g/equivalent)×10

### Surfactant System

The cleaning composition comprises from about 5% to about 15%, preferably from about 6% to about 14%, more preferably from about 7% to about 12%, most preferably from about 8% to about 10% by weight thereof of a surfactant system. The surfactant system preferably comprises an anionic surfactant, more preferably a sulfate surfactant or a sulfosuccinate anionic surfactant. The system preferably comprises a further surfactant preferably selected from the group consisting of amphoteric surfactants, zwitterionic surfactants and mixtures thereof. The system can optionally comprise a non-ionic surfactant.

Alkyl sulfates are preferred for use herein, especially alkyl ethoxy sulfates; more preferably alkyl ethoxy sulfates with an average degree of ethoxylation from about 2 to about 5, most preferably about 3. Branched short chain alkyl sulfate surfactant are also preferred for use herein.

Sulfosuccinate anionic surfactants are also preferred for use herein in particular 2 ethylhexylsulfosuccinate.

The surfactant system preferably comprises an amphoteric and/or zwitterionic surfactant, preferably the amphoteric surfactant comprises an amine oxide and the zwitteronic surfactant comprises a sulfobetaine or a betaine surfactant.

Preferably, the anionic surfactant and the further surfactant are present in the composition of the invention in a weight ratio of about 5:1 to about 1:5 preferably of about 4:1 to about 1:1, preferably from 3:1 to 1:1 and more preferably from 2.8:1 to 1.3:1.

A preferred surfactant system for the detergent composition of the present invention comprise: (1) 4% to 10%, preferably 5% to 8% by weight of the composition of an anionic surfactant, preferably an alkyl alkoxy sulfate surfactant or a branched short chain alkyl sulfate; (2) 1% to 5%, preferably from 1% to 4% by weight of the composition of a surfactant selected from the group consisting of amphoteric surfactant, zwitterionic surfactant and mixtures thereof, preferably an amine oxide surfactant. It has been found that such surfactant system in combination with the ester of the invention provides excellent cleaning and good foaming profile.

### Anionic Surfactant

Anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will comprise a linear or branched C8-C22 alkyl, or acyl group. Such surfactants are employed in the form of water-soluble salts and the salt-forming cation usually is selected from sodium, potassium, ammonium, magnesium and mono-, di- or tri-alkanolammonium, with the sodium, cation being the usual one chosen.

The anionic surfactant is preferably a sulfate surfactant. A preferred sulfate surfactant is alkyl ethoxy sulfate, more preferably an alkyl ethoxy sulfate with an average degree of ethoxylation from about 2 to about 5, most preferably about 3. Another preferred sulfate surfactant is a branched short chain alkyl suphate, in particular 2-ethyl hexyl sulfate.

### Sulfate Anionic Surfactant

A preferred sulfate anionic surfactant is an alkoxylated, more preferably, an alkoxylated sulfate anionic surfactant having an average alkoxylation degree from about 2 to about 5, most preferably about 3. Preferably, the alkoxy group is ethoxy. When the sulfate anionic surfactant is a mixture of sulfate anionic surfactants, the average alkoxylation degree is the weight average alkoxylation degree of all the components of the mixture (weight average alkoxylation degree). In the weight average alkoxylation degree calculation the weight of sulfated anionic surfactant components not having alkoxylate groups should also be included.

Weight average alkoxylation degree=(x1*alkoxylation degree of surfactant 1+x2*alkoxylation degree of surfactant 2+ . . . )/(x1+x2+ . . . )

wherein x1, x2, are the weights in grams of each sulfate anionic surfactant of the mixture and alkoxylation degree is the number of alkoxy groups in each sulfate anionic surfactant.

If the surfactant is branched, the preferred branching group is an alkyl. Typically, the alkyl is selected from methyl, ethyl, propyl, butyl, pentyl, cyclic alkyl groups and mixtures thereof. Single or multiple alkyl branches could be present on the main hydrocarbyl chain of the starting alcohol(s) used to produce the sulfate anionic surfactant used in the detergent of the invention.

The branched sulfate anionic surfactant can be a single anionic surfactant or a mixture of anionic surfactants. In the case of a single surfactant the percentage of branching refers to the weight percentage of the hydrocarbyl chains that are branched in the original alcohol from which the surfactant is derived.

In the case of a surfactant mixture the percentage of branching is the weight average and it is defined according to the following formula:

Weight average of branching (%)=[(x1*wt % branched alcohol 1 in alcohol 1+x2*wt % branched alcohol 2 in alcohol 2+ . . . )/(x1+x2+ . . . )]*100

wherein x1, x2, are the weight in grams of each alcohol in the total alcohol mixture of the alcohols which were used as starting material for the anionic surfactant for the detergent of the invention. In the weight average branching degree calculation the weight of anionic surfactant components not having branched groups should also be included.

When the surfactant system comprises a branched anionic surfactant, the surfactant system comprises at least 50%, more preferably at least 60% and preferably at least 70% of branched anionic surfactant by weight of the surfactant system, more preferably the branched anionic surfactant comprises more than 50% by weight thereof of an alkyl ethoxylated sulfate having an average ethoxylation degree of from about 2 to about 5 and preferably a level of branching of from about 5% to about 40%.

Suitable sulfate surfactants for use herein include water-soluble salts of C8-C18 alkyl, preferably C8-C18 alkyl comprising more than 50% by weight of the C8 to C18 alkyl of C12 to C14 alkyl or hydroxyalkyl, sulfate and/or ether sulfate. Suitable counterions include alkali metal cation earth alkali metal cation, alkanolammonium or ammonium or substituted ammonium, but preferably sodium.

The sulfate surfactants may be selected from C8-C18 alkyl alkoxy sulfates (AExS) wherein preferably x is from 1-30 in which the alkoxy group could be selected from ethoxy, propoxy, butoxy or even higher alkoxy groups and mixtures thereof. Especially preferred for use herein is a C12-C14 alkyl ethoxy sulfate with an average degree of ethoxylation from about 2 to about 5, preferably about 3.

Alkyl alkoxy sulfates are commercially available with a variety of chain lengths, ethoxylation and branching degrees. Commercially available sulfates include, those based on Neodol alcohols ex the Shell company, Lial-Isalchem and Safol ex the Sasol company, natural alcohols ex The Procter & Gamble Chemicals company.

If the anionic surfactant is branched, it is preferred that the branched anionic surfactant comprises at least 50%, more preferably at least 60% and especially at least 70% of a sulfate surfactant by weight of the branched anionic surfactant. Preferred from a cleaning view point are those branched surfactants in which the branched anionic surfactant comprises more than 50%, more preferably at least 60% and especially at least 70% by weight thereof of sulfate surfactant and the sulfate surfactant is selected from the group consisting of alkyl sulfate, alkyl ethoxy sulfates and mixtures thereof. Even more preferred are those in which the branched anionic surfactant has an average degree of ethoxylation of from about 2 to about 5, more preferably about 3 and even more preferably when the anionic surfactant has an average level of branching of from about 10% to about 35%, %, more preferably from about 20% to 30%.

Linear alkyl alkoxylate sulfate surfactants are preferred for use in the composition of the invention.

### Branched Short Chain Alkyl Sulfate Surfactant

This type of anionic surfactants has been found to deliver strong grease cleaning. They also present good foaming performance, when used in combination with amine oxide or betaine especially amine oxide surfactants, especially immediate foaming performance upon spraying.

The branched short chain alkyl sulfate surfactants according to the current invention have a linear alkyl sulfate backbone comprising from 4 to 8 carbon atoms, substituted with one or more C1-05 alkyl branching groups in the C1, C2 or C3 position on the linear alkyl sulfate backbone. The sulfate group within the branched short chain alkyl sulfate surfactant is bonded directly to said C4-C8 linear backbone in terminal position.

Preferably the linear alkyl sulfate backbone comprises from 5 to 7 carbon atoms. Preferably the one or more alkyl branching groups are selected from methyl, ethyl, propyl or isopropyl. Preferably the branched short chain alkyl sulfate surfactant has only one branching group substituted on its linear backbone chain. Preferably the alkyl branching group is on the C2 position in the linear alkyl sulfate backbone.

More preferably the branched short chain alkyl sulfate according to the current invention has a linear alkyl backbone comprising from 5 to 7 carbons, substituted on the C2 position in the linear alkyl sulfate backbone with one alkyl branching group selected from methyl, ethyl, propyl. Most preferably the branched short chain alkyl sulfate surfactant is 2-ethylhexylsulfate. This compound is commercially available under the Syntapon EH tradename from Enaspol and Empicol 0585U from Huntsman.

The branched short chain alkyl sulfate surfactant will be formulated from about 3% to about 10%, preferably from about 4% to about 8% by weight of the composition.

The branched short chain alkyl sulfate surfactant will be formulated from about 50% to about 100%, preferably from about 55% to about 75% by weight of the total surfactant composition.

### Amphoteric Surfactant

Preferably the amphoteric surfactant is an amine oxide. Preferred amine oxides are alkyl dimethyl amine oxide or alkyl amido propyl dimethyl amine oxide, more preferably alkyl dimethyl amine oxide and especially coco dimethyl amino oxide. Amine oxide may have a linear or mid-branched alkyl moiety. Typical linear amine oxides include water-soluble amine oxides containing one R1 C8-18 alkyl moiety and 2 R2 and R3 moieties selected from the group consisting of C1-3 alkyl groups and C1-3 hydroxyalkyl groups. Preferably amine oxide is characterized by the formula R1-N(R2)(R3) O wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the α carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein.

The amine oxide further comprises two moieties, independently selected from a C1-3 alkyl, a C1-3 hydroxyalkyl group, or a polyethylene oxide group containing an average of from about 1 to about 3 ethylene oxide groups. Preferably the two moieties are selected from a C1-3 alkyl, more preferably both are selected as a C1 alkyl.

### Zwitterionic Surfactant

Other suitable surfactants include zwitterionic surfactants, preferably betaines, such as alkyl betaines, alkylamidobetaine, amidazoliniumbetaine, sulfobetaine (INCI Sultaines) and phosphobetaines. A preferred betaine is, for example, Cocoamidopropylbetaine.

Alternatively the zwitterionic surfactant can be a sulfobetaine surfactant, preferably Laurylhydroxysulfobetaine.

### Non Ionic Surfactant

Nonionic surfactant, when present, is comprised in a typical amount of from 0.1% to 10%, preferably 0.2% to 8%, most preferably 0.5% to 6% by weight of the composition. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol. Highly preferred nonionic surfactants are the condensation products of guerbet alcohols with from 2 to 18 moles, preferably 2 to 15, more preferably 5-12 of ethylene oxide per mole of alcohol.

Other suitable non-ionic surfactants for use herein include fatty alcohol polyglycol ethers, preferably 2-ethylhexylglycerol ether, alkylpolyglucosides and fatty acid glucamides.

### Ester

The composition of the invention comprises from 0.1 to 15%, preferably from 2 to 10%, more preferably from 2 to 8%, even more preferably from 3 to 7% most preferably from 4 to 6% by weight of the composition of an ester selected from the group consisting of:
a) monoester according to the formula R1C═OOR2wherein:
   R1 is a linear or branched C1 to C4 alkyl, preferably a linear or branched C2 or C3 alkyl;
   R2 is a linear or branched C2 to C8 alkyl, preferably a linear or branched C2 to C6 alkyl, most preferably a linear or branched C3 to C4 alkyl;
b) di- or tri-ester according to the formula R1(C═OOR2)n wherein:
   R1 is a saturated or unsaturated C2 to C4 alkyl;
   R2 is independently selected from a linear or branched C2 to C8 alkyl, preferably a linear or branched C2 to C6 alkyl, most preferably a linear of branched C3 to C4 alkyl;
   n is 2 or 3, preferably 2;
c) benzylbenzoate; and
d) mixtures thereof.

Suitable monoesters include ethylacetate, propylacetate, isopropylacetate, butylacetate, isobutylacetate, amylacetate, isoamylacetate, hexylacetate, isohexylacetate, heptylacetate, isoheptylacetate, octylacetate, isooctylacetate, 2-ethylhexylacetate, ethylpropionate, propylpropionate, isopropylpropionate, butylpropionate, isobutylpropionate, amylpropionate, isoamylpropionate, hexylpropionate, isohexylpropionate, heptylpropionate, isoheptylpropionate, octylpropionate, isooctylpropionate, 2-ethylhexylpropionate, ethylbutyrate, propylbutyrate, isopropylbutyrate, butylbutyrate, isobutylbutyrate, amylbutyrate, isoamylbutyrate, hexylbutyrate, isohexylbutyrate, heptylbutyrate, isoheptylbutyrate, octylbutyrate, isooctylbutyrate, 2-ethylhexylbutyrate, ethylisobutyrate, propylisobutyrate, isopropylisobutyrate, butylisobutyrate, isobutylisobutyrate, amylisobutyrate, isoamylisobutyrate, hexylisobutyrate, isohexylisobutyrate, heptylisobutyrate, isoheptylisobutyrate, octylisobutyrate, isooctylisobutyrate, 2-ethylhexylisobutyrate, ethylpentanoate, propylpentanoate, isopropylpentanoate, butylpentanoate, isobutylpentanoate, amylpentanoate, isoamylpentanoate, hexylpentanoate, isohexylpentanoate, heptylpentanoate, isoheptylpentanoate, octylpentanoate, isooctylpentanoate, 2-ethylhexylpentanoate, ethylisopentanoate, propylisopentanoate, isopropylisopentanoate, butylisopentanoate, isobutylisopentanoate, amylisopentanoate, isoamylisopentanoate, hexylisopentanoate, isohexylisopentanoate, heptylisopentanoate, isoheptylisopentanoate, octylisopentanoate, isooctylisopentanoate, 2-ethylhexylisopentanoate, and mixtures thereof.

Preferably the monoesters are selected from the group consisting of ethylpropionate, propylpropionate, isopropylpropionate, butylpropionate, isobutylpropionate, amylpropionate, isoamylpropionate, hexylpropionate, isohexylpropionate, ethylbutyrate, propylbutyrate, isopropylbutyrate, butylbutyrate, isobutylbutyrate, amylbutyrate, isoamylbutyrate, hexylbutyrate, isohexylbutyrate, ethylisobutyrate, propylisobutyrate, isopropylisobutyrate, butylisobutyrate, isobutylisobutyrate, amylisobutyrate, isoamylisobutyrate, hexylisobutyrate, isohexylisobutyrate, and mixtures thereof.

Most preferably the monoesters are selected from the group consisting of propylpropionate, isopropylpropionate, butylpropionate, isobutylpropionate, propylbutyrate, isopropylbutyrate, butylbutyrate, isobutylbutyrate, propylisobutyrate, isopropylisobutyrate, butylisobutyrate, isobutylisobutyrate, and mixtures thereof.

Suitable di- or tri-esters include ethyl-, propyl-, isopropyl-, butyl-, isobutyl-, amyl-, isoamyl-, hexyl-, isohexyl-, heptyl-, isoheptyl, octyl-, isooctyl-, 2-ethylhexy- di- or tri-esters of succinic acid, glutaric acid, adipic acid, maleic acid, fumaric acid, glutaconic acid, citric acid, aconitic acid, propane-1,2,3-tricarboxylic acid, and mixtures thereof.

Preferably di- or tri-esters are selected from the group consisting of ethyl-, propyl-, isopropyl-, butyl-, isobutyl-, amyl-, isoamyl-,hexyl-, isohexyl- di- or tri-esters of succinic acid, glutaric acid, adipic acid, maleic acid, fumaric acid, glutaconic acid, citric acid, aconitic acid, propane-1,2,3-tricarboxylic acid, and mixtures thereof.

More preferably di- or tri-esters are selected from the group consisting of ethyl-, propyl-, isopropyl-, butyl-, isobutyl- di- or tri-esters of succinic acid, glutaric acid, adipic acid, maleic acid, fumaric acid, glutaconic acid, citric acid, aconitic acid, propane-1,2,3-tricarboxylic acid, and mixtures thereof.

Another suitable ester solvent is benzylbenzoate.

### Alcohol

The composition of the invention may comprise from 0.1 to 10%, preferably from 1 to 9%, more preferably from 2 to 8%, most preferably from 4 to 6% by weight of the composition of an alcohol selected from the group consisting of C4-C6 linear mono-alcohols, branched C4-C10 mono-alcohols having one or more C1-C4 branching groups, alkyl mono-glycerols, and mixtures thereof.

Preferred C4-C6 linear mono-alcohols are selected from pentanol, hexanol, and mixtures thereof, preferably 1-pentanol, 1-hexanol, and mixtures thereof.

Preferred branched C4-C10 mono-alcohols having one or more C1-C4 branching groups for use herein are C4-C8 primary mono-alcohols having one or more C1-C4 branching groups, and mixtures thereof. Especially preferred branched C4-C10 mono-alcohols having one or more C1-C4 branching groups for use herein include methyl butanol, ethyl butanol, methyl pentanol, ethyl pentanol, methyl hexanol, ethyl hexanol, propyl hexanol, dimethyl hexanol trimethyl hexanol, methyl hepanol, ethyl heptanol, propyl heptanol, dimethyl heptanol,trimethyl heptanol, methyl octanol, ethyl octanol, propyl octanol, butyl octanol, dimethyl octanol, trimethyl octanol, methyl nonanol, ethyl nonanol, propyl nonanol, butyl nonanol, dimethyl nonanol and trimethyl nonanol, and mixtures thereof. More preferred for use herein are the primary 1-alcohol member of branched C4-C10 mono-alcohols having one or more C1-C4 branching groups, especially preferred are the primary 1-alcohol family members of methyl butanol, ethyl butanol, methyl pentanol, ethyl pentanol, methyl hexanol, ethyl hexanol, propyl hexanol, dimethyl hexanol trimethyl hexanol, methyl hepanol, ethyl heptanol, propyl heptanol, dimethyl heptanol,trimethyl heptanol, methyl octanol, ethyl octanol, propyl octanol, butyl octanol, dimethyl octanol, trimethyl octanol, methyl nonanol, ethyl nonanol, propyl nonanol, butyl nonanol, dimethyl nonanol, trimethyl nonanol, and mixtures thereof.

More preferred alcohols are butyl octanol, trimethyl hexanol, ethyl hexanol, propyl heptanol, methyl butanol, and mixtures thereof, in particular the primary 1-alcohol family member, more in particular ethyl hexanol, butyl octanol, trimethyl hexanol, and mixtures thereof, especially 2-ethyl-1-hexanol, 2-butyl-1-octanol, 3,5,5 trimethyl-1-hexanol, and mixtures thereof.

Preferred alkyl mono-glycerols are selected from the group consisting of branched alkyl mono-glycerols and mixtures thereof, more preferably branched C4-C8 alkyl mono-glycerols with one or more C1 to C4 alkyl branching groups, more preferably selected from the group consisting of ethylhexylglycerol, propylheptylglycerol, and mixtures thereof, most preferably 2-ethylhexylglycerol.

The alcohol of the product of the invention can boost foaming.

Especially preferred for use herein are mixtures of mono-alcohols, in particular mixtures comprising a branched C4-C10 mono-alcohol, more in particular mixtures comprising an alcohol selected from the group comprising C4-C8 more preferably C6-C7 branched primary alcohols. Preferably for use is a mixture of alcohols comprising an alcohol selected from the group comprising C4-C8 branched primary alcohols with an alcohol selected of the group of C4-C6 linear mono-alcohols and alkylglycerols. Mixtures can boost foaming and improve cleaning over a plurality of different oily soils.

### Glycol Ether Solvent

The composition of the invention can comprise a glycol ether solvent selected from glycol ethers of Formula I or Formula II.

Formula I=R1O(R2O)nR3 wherein R1 is a linear or branched C4, C5 or C6 alkyl, a substituted or unsubstituted phenyl, preferably n-butyl. Benzyl is one of the substituted phenyls for use herein. R2 is ethyl or isopropyl, preferably isopropyl. R3 is hydrogen or methyl, preferably hydrogen. n is 1, 2 or 3, preferably 1 or 2

Formula II=R4O(R5O)nR6 wherein R4 is n-propyl or isopropyl, preferably n-propyl. R5 is isopropyl. R6 is hydrogen or methyl, preferably hydrogen n is 1, 2 or 3 preferably 1 or 2.

Suitable glycol ether solvents according to Formula I include ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, ethyleneglycol n-pentyl ether, diethyleneglycol n-pentyl ether, triethyleneglycol n-pentyl ether, propyleneglycol n-pentyl ether, dipropyleneglycol n-pentyl ether, tripropyleneglycol n-pentyl ether, ethyleneglycol n-hexyl ether, diethyleneglycol n-hexyl ether, triethyleneglycol n-hexyl ether, propyleneglycol n-hexyl ether, dipropyleneglycol n-hexyl ether, tripropyleneglycol n-hexyl ether, ethyleneglycol phenyl ether, diethyleneglycol phenyl ether, triethyleneglycol phenyl ether, propyleneglycol phenyl ether, dipropyleneglycol phenyl ether, tripropyleneglycol phenyl ether, ethyleneglycol benzyl ether, diethyleneglycol benzyl ether, triethyleneglycol benzyl ether, propyleneglycol benzyl ether, dipropyleneglycol benzyl ether, tripropyleneglycol benzyl ether, ethyleneglycol isobutyl ether, diethyleneglycol isobutyl ether, triethyleneglycol isobutyl ether, propyleneglycol isobutyl ether, dipropyleneglycol isobutyl ether, tripropyleneglycol isobutyl ether, ethyleneglycol isopentyl ether, diethyleneglycol isopentyl ether, triethyleneglycol isopentyl ether, propyleneglycol isopentyl ether, dipropyleneglycol isopentyl ether, tripropyleneglycol isopentyl ether, ethyleneglycol isohexyl ether, diethyleneglycol isohexyl ether, triethyleneglycol isohexyl ether, propyleneglycol isohexyl ether, dipropyleneglycol isohexyl ether, tripropyleneglycol isohexyl ether, ethyleneglycol n-butyl methyl ether, diethyleneglycol n-butyl methyl ether triethyleneglycol n-butyl methyl ether, propyleneglycol n-butyl methyl ether, dipropyleneglycol n-butyl methyl ether, tripropyleneglycol n-butyl methyl ether, ethyleneglycol n-pentyl methyl ether, diethyleneglycol n-pentyl methyl ether, triethyleneglycol n-pentyl methyl ether, propyleneglycol n-pentyl methyl ether, dipropyleneglycol n-pentyl methyl ether, tripropyleneglycol n-pentyl methyl ether, ethyleneglycol n-hexyl methyl ether, diethyleneglycol n-hexyl methyl ether, triethyleneglycol n-hexyl methyl ether, propyleneglycol n-hexyl methyl ether, dipropyleneglycol n-hexyl methyl ether, tripropyleneglycol n-hexyl methyl ether, ethyleneglycol phenyl methyl ether, diethyleneglycol phenyl methyl ether, triethyleneglycol phenyl methyl ether, propyleneglycol phenyl methyl ether, dipropyleneglycol phenyl methyl ether, tripropyleneglycol phenyl methyl ether, ethyleneglycol benzyl methyl ether, diethyleneglycol benzyl methyl ether, triethyleneglycol benzyl methyl ether, propyleneglycol benzyl methyl ether, dipropyleneglycol benzyl methyl ether, tripropyleneglycol benzyl methyl ether, ethyleneglycol isobutyl methyl ether, diethyleneglycol isobutyl methyl ether, triethyleneglycol isobutyl methyl ether, propyleneglycol isobutyl methyl ether, dipropyleneglycol isobutyl methyl ether, tripropyleneglycol isobutyl methyl ether, ethyleneglycol isopentyl methyl ether, diethyleneglycol isopentyl methyl ether, triethyleneglycol isopentyl methyl ether, propyleneglycol isopentyl methyl ether, dipropyleneglycol isopentyl methyl ether, tripropyleneglycol isopentyl methyl ether, ethyleneglycol isohexyl methyl ether, diethyleneglycol isohexyl methyl ether, triethyleneglycol isohexyl methyl ether, propyleneglycol isohexyl methyl ether, dipropyleneglycol isohexyl methyl ether, tripropyleneglycol isohexyl methyl ether, and mixtures thereof.

Preferred glycol ether solvents according to Formula I are ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, and mixtures thereof.

Most preferred glycol ethers according to Formula I are propyleneglycol n-butyl ether, dipropyleneglycol n-butyl ether, and mixtures thereof.

Suitable glycol ether solvents according to Formula II include propyleneglycol n-propyl ether, dipropyleneglycol n-propyl ether, tripropyleneglycol n-propyl ether, propyleneglycol isopropyl ether, dipropyleneglycol isopropyl ether, tripropyleneglycol isopropyl ether, propyleneglycol n-propyl methyl ether, dipropyleneglycol n-propyl methyl ether, tripropyleneglycol n-propyl methyl ether, propyleneglycol isopropyl methyl ether, dipropyleneglycol isopropyl methyl ether, tripropyleneglycol isopropyl methyl ether, and mixtures thereof.

Preferred glycol ether solvents according to Formula II are propyleneglycol n-propyl ether, dipropyleneglycol n-propyl ether, and mixtures thereof.

Most preferred glycol ether solvents are propyleneglycol n-butyl ether, dipropyleneglycol n-butyl ether, and mixtures thereof, especially dipropyleneglycol n-butyl ether.

Suitable glycol ether solvents can be purchased from The Dow Chemical Company, more particularly from the E-series (ethylene glycol based) Glycol Ethers and the P-series (propylene glycol based) Glycol Ethers line-ups. Suitable glycol ether solvents include Butyl Carbitol, Hexyl Carbitol, Butyl

Cellosolve, Hexyl Cellosolve, Butoxytriglycol, Dowanol Eph, Dowanol PnP, Dowanol DPnP, Dowanol PnB, Dowanol DPnB, Dowanol TPnB, Dowanol PPh, and mixtures thereof.

The glycol ether of the product of the invention can boost foaming.

Mixtures of an alcohol, in particular a C4-C8 branched primary mono-alcohol with a glycol ether of Formula I, II or mixtures thereof have also been found to provide an unexpected good cleaning and speed of cleaning. Ethylhexanol especially 2-ethyl-1-hexanol, propylhexanol especially 2-propyl-1-heptanol, and methyl hexanol, in particular trimethyl hexanol especially 3,5,5trimethyl-1-hexanol, have been found particularly good when they are part of a mixture, in terms of cleaning and speed of cleaning, especially mixtures of these alcohols with propyleneglycol n-butyl ether, dipropyleneglycol n-butyl ether, and mixtures thereof, especially dipropyleneglycol n-butyl ether.

The mixtures of alcohols and glycol ethers can boost foaming.

The glycol ether solvent typically is present from about 1% to about 10%, preferably from about 2 to about 8%, most preferably from about 3% to about 7% by weight of the composition. Preferably, weight ratio glycol ether to alcohol is from about 9:1 to about 1:9, preferably from about 7:3 to about 3:7 and more preferably from about 3:2 to about 2:3.

### Cleaning Amine

The composition of the invention preferably comprises from about 0.1% to about 10%, more preferably from about 0.2% to about 5%, and especially from about 0.3% to about 2%, by weight of the composition, of a cleaning amine. The term “cleaning amine” herein encompasses a single cleaning amine and a mixture thereof. A “cleaning amine” herein means a molecule comprising amine functionalities that helps cleaning as part of a cleaning composition.

The amine can be subjected to protonation depending on the pH of the cleaning medium in which it is used.

Preferably the cleaning amine is a cyclic diamine of Formula (I):

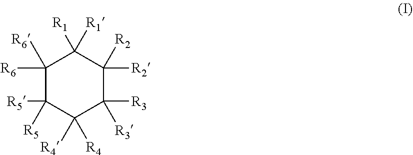

two of the substituents Rₛ(R₁-R₆, R₁′-R₆′) are independently selected from the group consisting of NH2, (C1-C4)NH2 and mixtures thereof and the remaining substituents Rₛ are independently selected from H, linear or branched alkyl or alkenyl having from 1 to 10 carbon atoms.

The term “cyclic diamine” herein encompasses a single cleaning amine and a mixture thereof. The amine can be subjected to protonation depending on the pH of the cleaning medium in which it is used.

The amine of Formula (I) is a cyclic amine with two primary amine functionalities. The primary amines can be in any position in the cycle but it has been found that in terms of grease cleaning, better performance can be obtained when the primary amines are in positions 1,3. It has also been found advantageous in terms of grease cleaning amines in which one of the substituents is —CH3 and the rest are H.

Preferred cyclic diamines for use herein are selected from the group consisting of:

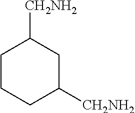

1,3-bis(methylamine)-cyclohexane,

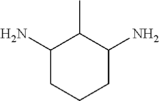

2-methylcyclohexane-1,3-diamine,

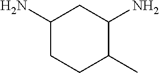

4-methylcyclohexane-1,3-diamine,

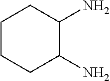

Cyclohexane-1,2-diamine

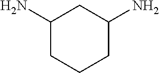

Cyclohexane-1,3-diamine,

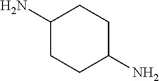

Cyclohexane-1,4-diamine,

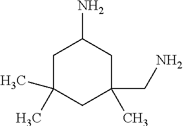

Isophorone diamine; and a mixture thereof.

Especially preferred for use herein are cyclic diamines selected from the group consisting of 1,3-bis(methylamine)-cyclohexane, 2-methylcyclohexane-1,3-diamine, 4-methylcyclohexane-1,3-diamine and mixtures thereof. 1,3-bis(methylamine)-cyclohexane is especially preferred for use herein. Mixtures of 2-methylcyclohexane-1,3-diamine, 4-methylcyclohexane-1,3-diamine are also preferred for use herein.

Preferred cleaning amines include polyetheramines. One of the polyetheramine preferred for use in the composition of the invention is represented by the structure of Formula (I):

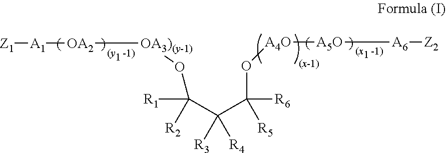

where each of R₁-R₆ is independently selected from H, alkyl, cycloalkyl, aryl, alkylaryl, or arylalkyl, where at least one of R₁-R₆ is different from H, typically at least one of R₁-R₆ is an alkyl group having 2 to 8 carbon atoms, each of A₁-A₆ is independently selected from linear or branched alkylenes having 2 to 18 carbon atoms, each of Z₁-Z₂ is independently selected from OH or NH₂, where at least one of Z₁-Z₂ is NH₂, typically each of Z₁ and Z₂ is NH₂, where the sum of x+y is in the range of about 2 to about 200, typically about 2 to about 20, more typically about 2 to about 10 or about 3 to about 8 or about 4 to about 6, where x≥1 and y≥1, and the sum of x₁+y₁ is in the range of about 2 to about 200, typically about 2 to about 20, more typically about 2 to about 10 or about 3 to about 8 or about 2 to about 4, where x₁≥1 and y₁≥1.

Preferably in the polyetheramine of Formula (I), each of A₁-A₆ is independently selected from ethylene, propylene, or butylene, typically each of A₁-A₆ is propylene. More preferably, in the polyetheramine of Formula (I), each of R₁, R₂, R₅, and R₆ is H and each of R₃ and R₄ is independently selected from C1-C16 alkyl or aryl, typically each of R₁, R₂, R₅, and R₆ is H and each of R₃ and R₄ is independently selected from a butyl group, an ethyl group, a methyl group, a propyl group, or a phenyl group. More preferably, in the polyetheramine of Formula (I), R₃ is an ethyl group, each of R₁, R₂, R₅, and R₆ is H, and R₄ is a butyl group. Especially, in the polyetheramine of Formula (I), each of R₁ and R₂ is H and each of R₃, R₄, R₅, and R₆ is independently selected from an ethyl group, a methyl group, a propyl group, a butyl group, a phenyl group, or H.

In the polyetheramine represented by the structure of Formula (II):

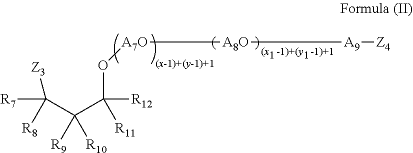

each of R₇-R₁₂ is independently selected from H, alkyl, cycloalkyl, aryl, alkylaryl, or arylalkyl, where at least one of R₇-R₁₂ is different from H, typically at least one of R₇-R₁₂ is an alkyl group having 2 to 8 carbon atoms, each of A₇-A₉ is independently selected from linear or branched alkylenes having 2 to 18 carbon atoms, each of Z₃-Z₄ is independently selected from OH or NH₂, where at least one of Z₃-Z₄ is NH₂, typically each of Z₃ and Z₄ is NH₂, where the sum of x+y is in the range of about 2 to about 200, typically about 2 to about 20, more typically about 2 to about 10 or about 3 to about 8 or about 2 to about 4, where x≥1 and y≥1, and the sum of x₁+y₁ is in the range of about 2 to about 200, typically about 2 to about 20, more typically about 2 to about 10 or about 3 to about 8 or about 2 to about 4, where x₁≥1 and y₁≥1.

Preferably in the polyetheramine of Formula (II), each of A₇-A₉ is independently selected from ethylene, propylene, or butylene, typically each of A₇-A₉ is propylene. More preferably, in the polyetheramine of Formula (II), each of R₇, R₈, R₁₁, and R₁₂ is H and each of R₉ and Rio is independently selected from C1-C16 alkyl or aryl, typically each of R₇, R₈, R₁₁, and R₁₂ is H and each of R₉ and Rio is independently selected from a butyl group, an ethyl group, a methyl group, a propyl group, or a phenyl group. More preferably, in the polyetheramine of Formula (II), R₉ is an ethyl group, each of R₇, R₈, R₁₁, and R₁₂ is H, and R₁₀ is a butyl group. In some aspects, in the polyetheramine of Formula (II), each of R₇ and R₈ is H and each of R₉, R₁₀, R₁₁, and R₁₂ is independently selected from an ethyl group, a methyl group, a propyl group, a butyl group, a phenyl group, or H.

Preferred polyetheramines are selected from the group consisting of Formula A, Formula B, and mixtures thereof:

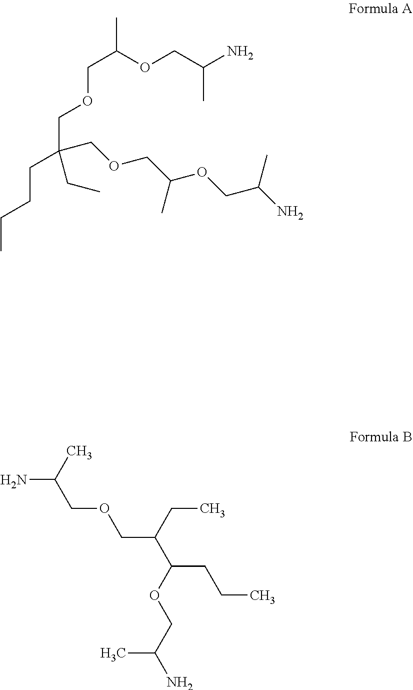 [SMILES: CCCCC(CC)(COCC(C)OCC(C)N)COCC(C)OCC(C)N ; CCCC(OCC(C)N)C(CC)COCC(C)N]

Preferably, the polyetheramine comprises a mixture of the compound of Formula (I) and the compound of Formula (II).

Typically, the polyetheramine of Formula (I) or Formula (II) has a weight average molecular weight of less than about grams/mole 1000 grams/mole, preferably from about 100 to about 800 grams/mole, more preferably from about 200 to about 450 grams/mole.

### Amine of Formula (1):

The cleaning amine of Formula (1) has an ethylene diamine core with at least one primary amine functionality. The cleaning amine also comprises at least another nitrogen atom, preferable in the form of a tertiary amine functionality. Herein the term “core” refers to the alkyl chain between two nitrogen radicals. The number of carbons in the core does not include the radicals attached to the core.

The cleaning amine has the formula:

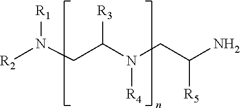

wherein: R₁, R₂, R₃, R₄, and R₅ are independently selected from -H, linear, branched or cyclic alkyl or alkenyl having from 1 to 10 carbon atoms and n=0-3.

Preferably, the cleaning amine is aliphatic in nature. The cleaning amine preferably has a molecular weight of less than about 1000 grams/mole and more preferably less than about 450 grams/mole.

“n” varies from 0 to not more than 3, preferably “n” is 0. The amine molecule contains at least one primary amine functionality and preferably a tertiary amine functionality.

Suitable cleaning amines for use herein include amines wherein R₁ and R₂ are selected from isopropyl and butyl, preferably R₁ and R₂ are both isopropyl or both butyl.

Preferably cleaning amines include those in which R₁ and R₂ are isopropyl and preferably, n is 0. Also preferred are amines in which R₁ and R₂ are butyl and preferably, n is 0

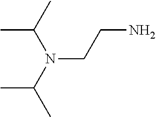

N₁,N₁-diisapropylethane-1,2-diamine

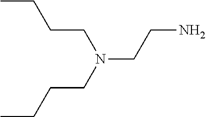

N¹,N¹-dibutylethane-1,2-diamine

R5 is preferably —CH3 or —CH2CH3. Cleaning amines in which R5 is —CH3 or —CH2CH3 could be good in terms of composition stability. Without being bound by theory, it is believed that the methyl or ethyl radical can provide stearic hinderance that protects the cleaning amine from negative interaction with other components of the cleaning composition.

### Amine of Formula (2):

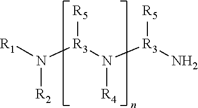

wherein R₁ and R₄ are independently selected from —H, linear, branched or cyclic alkyl or alkenyl; having from 1 to 10 carbon atoms and R₂ is a linear, branched or cyclic alkyl or alkenyl having from 3 to 10 carbons, R₃ is a linear or branched alkyl from 3 to 6 carbon atoms, R₅ is H, methyl or ethyl and is preferably located in alpha position from the amine functionality/ies, and n=0-3.

The cleaning amine of formula (2) has a C3-C6 diamine core with at least one of the amine functionalities being a primary amine. Herein the term “core” refers to the alkyl chain between two nitrogen radicals. The number of carbons in the core does not include the radicals attached to the core.

The cleaning amine of formula (2) preferably has a molecular weight of less than about 1000 grams/mole and more preferably less than about 450 grams/mole.

“n” varies from 0 to not more than 3, preferably “n” is 0. The amine molecule contains at least one primary amine functionality and preferably a tertiary amine functionality.

Suitable cleaning amines include amines wherein R₁ and R₂ are selected from propyl, butyl and hexyl, preferably R₁ and R₂ are both propyl, butyl or hexyl. Preferably n is 0.

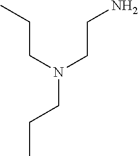

N′N′-dipropylpropane 1,3 ldiamine

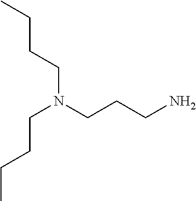

N¹,N¹-dibutylpropane-1,3-diamine

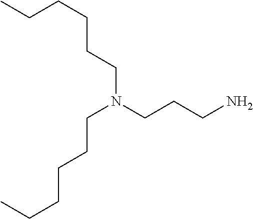 [SMILES: CCCCCCN(CCCN)CCCCCC]

N¹,N¹-dihexylpropane-1,3-diamine

Another preferred cleaning amine for use herein is cyclohexyl propylenediamine (wherein n=0, R1 is cyclohexanyl and R2 is H)

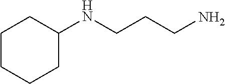 [SMILES: NCCCNC1CCCCC1]

The amine of formula (3):

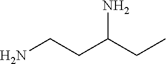

Is preferred for use herein

### Chelant

The composition herein may optionally further comprise a chelant at a level of from 0.1% to 10%, preferably from 0.2% to 5%, more preferably from 0.2% to 3%, most preferably from 0.5% to 1.5% by weight of the composition.

Suitable chelating agents can be selected from the group consisting of amino carboxylates, amino phosphonates, polyfunctionally- substituted aromatic chelating agents and mixtures thereof.

Amino carboxylates include ethylenediaminetetra-acetates, N-hydroxyethylethylenediaminetriacetates, nitrilo-triacetates, ethylenediamine tetraproprionates, triethylenetetraaminehexacetates, diethylenetriaminepentaacetates, and ethanoldiglycines, alkali metal, ammonium, and substituted ammonium salts therein and mixtures therein, as well as MGDA (methyl-glycine-diacetic acid), and salts and derivatives thereof and GLDA (glutamic-N,N- diacetic acid) and salts and derivatives thereof. GLDA (salts and derivatives thereof) is especially preferred according to the invention, with the tetrasodium salt thereof being especially preferred.

### Builder

The composition herein may comprise a builder, preferably a carboxylate builder. Salts of carboxylic acids useful herein include salts of C1-6 linear or at least 3 carbon containing cyclic acids. The linear or cyclic carbon-containing chain of the carboxylic acid or salt thereof may be substituted with a substituent group selected from the group consisting of hydroxyl, ester, ether, aliphatic groups having from 1 to 6, more preferably 1 to 4 carbon atoms, and mixtures thereof.

Preferred salts of carboxylic acids are those selected from the salts from the group consisting of salicylic acid, maleic acid, acetyl salicylic acid, 3 methyl salicylic acid, 4 hydroxy isophthalic acid, dihydroxyfumaric acid, 1,2,4 benzene tricarboxylic acid, pentanoic acid, citric acid, and mixtures thereof, preferably citric acid.

Alternative carboxylate builders suitable for use in the composition of the invention includes salts of fatty acids like palm kernel derived fatty acids or coconut derived fatty acid, or salts of polycarboxylic acids.

The cation of the salt is preferably selected from alkali metal, alkaline earth metal, monoethanolamine, diethanolamine or triethanolamine and mixtures thereof, preferably sodium.

The carboxylic acid or salt thereof, when present, is preferably present at the level of from 0.1% to 5%, more preferably from 0.2% to 1% by weight of the total composition.

### Shear Thinning Rheology Modifier

The composition according to the invention might further comprise a rheology modifying agent, providing a shear thinning rheology profile to the product. Preferably the rheology modifying agent is a non crystalline polymeric rheology modifier. This polymeric rheology modifier can be a synthetic or a naturally derived polymer.

Examples of naturally derived polymeric structurants of use in the present invention include: hydroxyethyl cellulose, hydrophobically modified hydroxyethyl cellulose, carboxymethyl cellulose, polysaccharide derivatives and mixtures thereof. Polysaccharide derivatives include but are not limited to pectine, alginate, arabinogalactan (gum Arabic), carrageenan, gum karaya, gum tragacanth, gellan gum, xanthan gum and guar gum. Examples of synthetic polymeric structurants of use in the present invention include polymers and copolymers comprising polycarboxylates, polyacrylates, polyurethanes, polyvinylpyrrolidone, polyols and derivatives and mixtures thereof.

Preferably the composition according to the invention comprises a naturally derived rheology modifying polymer, most preferably Xanthan Gum.

Generally, the rheology modifying polymer will be comprised at a level of from 0.001% to 1% by weight, alternatively from 0.01% to 0.5% by weight, more alternatively from 0.05% to 0.25% by weight of the composition.

### Further Optional Ingredients

The composition herein may comprise a number of optional ingredients such as rheology trimming agents selected from inorganic salts preferably sodium chloride, C1-C3 alcohols or polyols, alkylene glycols, poly alkylene glycols, hydrotropes, and mixtures thereof. The composition might also comprise pH trimming and/or buffering agents such as sodium hydroxyde, hydrogen chloride, alkanolamines including monoethanolamine, and bicarbonate inorganic salts. The composition might comprise further minor ingredients selected from preservatives, UV stabilizers, antioxidants, perfumes, coloring agents and mixtures thereof.

### Viscosity

The flow curve of products is measured with the use of a Rheometer (TA instruments—model DHR1), a Peltier concentric cylinder temperature system (TA instruments) and a double gap cup and rotor (TA instruments). The flow curve procedure comprises a conditioning step and a flow ramp step at 20° C., the conditioning step comprising a 30 s pre-shear step at a shear rate of 10 s-1 followed by a 120 s zero shear equilibration time. The flow ramp step comprises a Logarithmical shear rate increase from 0.001 s-1 to 10000 s-1 in a time span of 300 s. A data filter is set at the instrument recommended minimum torque value of 20 μNm.

“Low shear viscosity” is defined as the viscosity measured at a shear rate of 100 s-1. “High shear viscosity” is measured at a shear rate of 10000 s-1.

### Spray Dispenser

The spray dispenser comprises a housing to accommodate the composition of the invention and spraying means. Suitable spray dispensers include hand pump (sometimes referred to as “trigger”) devices, pressurized can devices, electrostatic spray devices, etc. Preferably the spray dispenser is non-pressurized and the spray means are of the trigger dispensing type.

### EXAMPLES

### Test Methods

### Oil Diffusion Test Method

The ability to diffuse through a layer of oil has been assessed for compositions comprising esters inside and outside of the scope of the product of the invention.

The ability of the compositions to penetrate oil was assessed by measuring the breakthrough time, using the following methodology: 35 gram of an aqueous solution containing 0.15% by weight of xanthan gum (supplied by Keltrol™ RD from CP-kelco) was poured into a glossy white ceramic dish plate (Supplied by Ikea—Item:S.Pryle #13781 diameter 26.5 cm).

Olive oil (Sold by Unilever under the Bertoli brand, item number L5313R H0756 MI0002) was dyed red through the addition of 0.05% by weight of red dye (Waxoline Red, red dye pigment supplied by Avecia), stirring for 1 hour in order to provide a homogeneous dye distribution. Then 2.5 grams of the dyed olive oil was delicately deposited onto the water surface thus forming a thin disk of oil layer. The oil disk diameter was measured to ensure that the diameter did not exceed a variation amongst the replicates of more than 20% from the average value. A drop of the cleaning composition was delicately deposited on to the oil layer, in the middle of the oil disk from a 5 ml Pasteur pipette (Supplied by VWR—Item: 5 ml #612-1684), from a height of less than 5 mm. The breakthrough time was measured as the time recorded from the deposition of the solution drop to the opening of the oil disk identified by the appearance of the water layer in the middle of the oil disk. 8 replicates were required per sample to calculate the average breakthrough time.

### Composition:

A reference base was formulated through mixing of individual raw materials at normal lab conditions, on top of which 5% by weight of the composition of the ester to be tested was added.

| % active by weight of the composition | Reference Base |
|---|---|
| Water and minors (preservative, perfume, dye) | To 100 parts |
| Sodium Chloride | 0.4 |
| Sodium bicarbonate | 0.1 |
| Ethanol | 0.34 |
| Polypropylene glycol MW 2000 | 0.05 |
| Mono-ethanolamine | 0.5 |
| Alkyl Dimethyl Amine Oxide (C12-14) | 6.67 |
| Non-ionic Alkyl Ethoxylate (C9-11EO8) | 1.33 |
| pH (10% dilution in demi water) | 10.1 |

### Results

The oil breakthrough time of compositions comprising 5% by weight of the composition of the different single esters inside and outside the scope of the invention was compared.

From the data in Table 1 below, it is clear that a composition comprising an ester according to the invention (Example esters) has a faster oil breakthrough time compared to the reference base formulation, while a composition comprising an ester solvent outside of the scope of the invention (Comparative example esters) has a slower oil breakthrough time compared to the reference base formulation.

TABLE 1
Impact of esters on oil breakthrough
time of the Reference Base formula.

| | Oil breakthrough time |
|---|---|
| | (seconds - the lower |
| Ester solvent | the better) |
| Nil ester solvent reference base | 63 |

Example esters
Monoesters:

| | |
|---|---|
| n-propyl acetate (R1 = C1, R2 = C3) | 43 |
| Amyl acetate (R1 = C1, R2 = C5) | 52 |
| 2-ethylhexyl acetate (R1 = C1, R2 = C8) | 57 |
| n-butyl propionate (R1 = C2, R2 = C4) | 53 |
| Isobutyl isobutyrate (R1 = iso-C3, | 26 |
| R2 = iso-C4) | |

Di-/Tri-esters:

| | |
|---|---|
| Diisobutyl adipate (di-ester, R1 = C4, | 28 |
| R2 = iso-C4) | |
| Dibutyl maleate (di-ester, R1 = unsaturated C2, | 45 |
| R2 = C4) | |
| Tri-n-butyl acetyl citrate (tri-ester, | 35 |
| R1 = C3, R2 = C4) | |

Alkyl benzoate:

| | |
|---|---|
| Benzyl benzoate | 28 |

Comparative Example esters
Monoesters:

| | |
|---|---|
| Ethylphenyl acetate (R1 = C1, R2 = C2-phenyl) | 119 |
| Methylbenzylacetate (R1 = C1, | 140 |
| R2 = methylbenzyl) | |
| 3-phenyl propionate (R1 = C2, R2 = phenyl) | 74 |
| Methyl oleate (R1 = C17, R2 = C1) | 73 |
| Ethyl oleate (R1 = C17, R2 = C1) | 72 |
| 2-ethylhexyl salicylate (R1 = hydroxyphenyl, | 187 |
| R2 = C8) | |

Di-/Tri-esters:

| | |
|---|---|
| Rhodiasolv IRIS (di-ester, R1 = iso-C4, | 107 |
| R2 = C1) | |
| Glycerol triacetate (tri-ester) | 76 |

Alkyl Benzoate:

| | |
|---|---|
| Ethyl benzoate | 174 |
| Butyl benzoate | 120 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning product comprising a spray dispenser and a cleaning composition suitable for spraying and foaming, the composition housed in the spray dispenser wherein the composition comprises:
i) from about 5% to about 15% by weight of the composition of a surfactant system, wherein the surfactant system comprises an anionic surfactant and at least one further surfactant, wherein the anionic surfactant comprises an alkyl ethoxylated sulfate surfactant; and
ii) from about 0.1% to about 15% by weight of the composition of an ester selected from the group consisting of :
a) monoesters having the formula R1C═OOR2 wherein:
R1 is a linear or branched C1 to C4 alkyl; and
R2 is a linear or branched C2 to C8 alkyl;
b) di- or tri-esters having the formula R1(C═OOR2)n wherein:
R1 is a saturated or unsaturated C2 to C4 alkyl;
R2 is independently selected from a linear or branched C2 to C8 alkyl; and
n is 2 or 3;
c) benzylbenzoate; and
d) mixtures thereof.

2. The product according to claim 1 wherein the ester is selected from the group consisting of:
a) monoesters having the formula R1C═OOR2 wherein:
R1 is a linear or branched C2 or C3 alkyl; and
R2 is a linear or branched C3 or C4 alkyl;
b) di- or tri-esters having the formula R1(C═OOR2)n wherein:
R1 is a saturated or unsaturated C2 to C4 alkyl;
R2 is independently selected from a linear or branched C3 or C4 alkyl; and
n is 2;
c) benzylbenzoate; and
d) mixtures thereof.

3. The product according to claim 1 wherein the esters are selected from the group consisting of:
a) monoesters selected from the group consisting of propylpropionate, isopropylpropionate, butylpropionate, isobutylpropionate, propylbutyrate, isopropylbutyrate, butylbutyrate, isobutylbutyrate, propylisobutyrate, isopropylisobutyrate, butylisobutyrate, isobutylisobutyrate, and mixtures thereof;
b) di- or tri-esters selected from the group consisting of ethyl-, propyl-, isopropyl-, butyl-, isobutyl- di- or tri-esters of succinic acid, glutaric acid, adipic acid, maleic acid, fumaric acid, glutaconic acid, citric acid, aconitic acid, propane-1,2,3-tricarboxylic acid, and mixtures thereof;
c) benzylbenzoate; and
d) mixtures thereof.

4. The product according to claim 1 wherein the ester comprises n-propyl acetate, n-amyl acetate, 2-ethylhexyl acetate, n-butyl propionate, isobutyl isobutyrate, diisobutyl adipate, dibutyl maleate, tri-n-butyl acetyl citrate, benzylbenzoate, or mixtures thereof.

5. The product according to claim 1 wherein the composition has a pH greater than 5 as measured at 10% solution in distilled water at 20° C.

6. The product according to claim 1 wherein the surfactant system and the ester are in a weight ratio of from about 5:1 to about 1:5.

7. The product according to claim 1 wherein the alkyl ethoxylated sulfate surfactant has an average degree of ethoxylation of from about 2 to about 5.

8. The product according to claim 7 wherein the alkyl ethoxylated sulfate surfactant has an average degree of ethoxylation of about 3.

9. The product according to claim 1 wherein the anionic surfactant and the at least one further surfactant are present in a weight ratio of about 5:1 to about 1:5 and wherein the at least one further surfactant is selected from the group consisting of amphoteric surfactant, zwitteronic surfactant and mixtures thereof.

10. The product according to claim 1 where the surfactant system further comprises a non-ionic surfactant.

11. The product according to claim 1 wherein the composition further comprises one or more ingredients selected from the group consisting of:
a. a glycol ether solvent selected from the group consisting of glycol ethers of Formula I: R1O(R2O)nR3, Formula II: R4O(R5O)nR6 and mixtures thereof wherein R1 is a linear or branched C4, C5 or C6 alkyl or a substituted or unsubstituted phenyl, R2 is ethyl or isopropyl, R3 is hydrogen or methyl and n is 1, 2 or 3, R4 is n-propyl or isopropyl, R5 is isopropyl, R6 is hydrogen or methyl and n is 1, 2 or 3;
b. an alcohol solvent selected from the group consisting of C4-C6 linear mono-alcohols, branched C4-C10 mono-alcohols having one or more C1-C4 branching groups, alkyl mono-glycerols, and mixtures thereof;
c. an alcohol solvent selected from the group consisting of C1-C3 linear of branched mono alcohols, C1-C3 polyols and mixtures thereof, a glycol solvent selected from the group consisting of ethyleneglycol, propyleneglycol, polyethyleneglycol, polypropyleneglycol, and mixtures thereof;
d. a hydrotrope selected from the group consisting of sodium cumene sulphonate, sodium xylene sulphonate, sodium toluene sulphonate, and mixtures thereof; and
e. mixtures thereof.

12. The product according to claim 1 wherein the composition further comprises a chelant selected from the group consisting of carboxylate; aminocarboxylate; aminophosphonate; and mixtures thereof.

13. The product according to claim 1 wherein the composition further comprises a cleaning amine selected from the group consisting of:
a. cyclic cleaning amine of Formula (I): 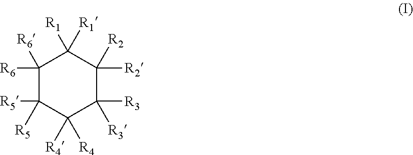
wherein two of the Rs, are selected from the group consisting of NH2, (C1-C4)NH2 and mixtures thereof and the remaining Rs are independently selected from H, linear or branched alkyl or alkenyl having from 1 to 10 carbon atoms;
b. polyetheramines of Formula (I), Formula (II), or Formula (III): 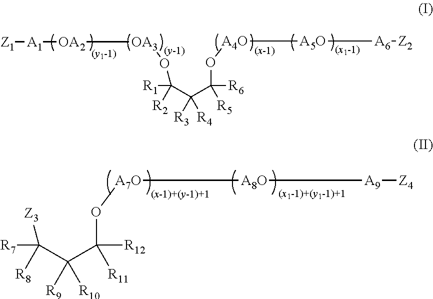
wherein each of R₁R₁₂ is independently selected from H, alkyl, cycloalkyl, aryl, alkylaryl, or arylalkyl, wherein at least one of R₁-R₆ and at least one of R₇-R₁₂ is different from H, each of A₁-A₉ is independently selected from linear or branched alkylenes having 2 to 18 carbon atoms, each of Z₁-Z₄ is independently selected from OH or NH₂, wherein at least one of Z₁-Z₂ and at least one of Z₃-Z₄ is NH₂, wherein the sum of x+y is in the range of about 2 to about 200, wherein x≥1 and y≥1, and the sum of x₁+y₁ is in the range of about 2 to about 200, wherein x₁≥1 and y₁≥1. 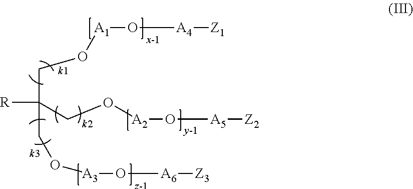
wherein R is selected from H or a C1-C6 alkyl group, each of k₁, k₂, and k₃ is independently selected from 0, 1, 2, 3, 4, 5, or 6, each of A₁, A₂, A₃, A₄, A₅, and A₆ is independently selected from a linear or branched alkylene group having from about 2 to about 18 carbon atoms or mixtures thereof, x≥1, y≥1, and z≥1, and the sum of x+y+z is in the range of from about 3 to about 100, each of Z₁, Z₂, and Z₃ is independently selected from NH₂ or OH, where at least two of Z₁, Z₂, and Z₃ are NH₂, and the polyetheramine has a weight average molecular weight of from about 150 to about 1000 grams/mole;
c. amines of Formula (1): 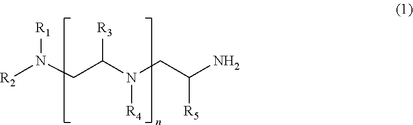
wherein: R₁, R₂, R₃, R₄, and R₅ are independently selected from —H, linear, branched or cyclic alkyl or alkenyl having from 1 to 10 carbon atoms and n=0-3;
d. amines of Formula (2): 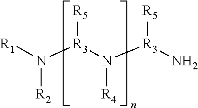
wherein R₁ and R₄ are independently selected from —H, linear, branched or cyclic alkyl or alkenyl having from 1 to 10 carbon atoms; and R₂ is a linear, branched or cyclic alkyl or alkenyl having from 3 to 10 carbons, R₃ is a linear or branched alkyl from 3 to 6 carbon atoms, R₅ is H, methyl or ethyl and n=0-3;
e. the amine of Formula (3) 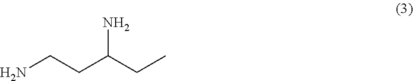
and
f. mixtures thereof.

14. The product according to claim 13 wherein the cyclic amine is selected from the group consisting of of 1,3-bis(methylamine)-cyclohexane, 2-methylcyclohexane-1,3-diamine, 4-methylcyclohexane-1,3-diamine and mixtures thereof.

15. The product according to claim 14 wherein the cyclic amine is selected from the group consisting of 2-methylcyclohexane-1,3-diamine, 4-methylcyclohexane-1,3-diamine and mixtures thereof.

16. A method of cleaning soiled dishware using the product according to claim 1, the method comprising the steps of:
a) optionally pre-wetting the soiled dishware;
b) spraying the cleaning composition onto the soiled dishware;
c) optionally adding water to the soiled dishware during a period of time;
d) optionally scrubbing the dishware; and
e) rinsing the dishware.

17. A cleaning product comprising a spray dispenser and a cleaning composition suitable for spraying and foaming, the composition housed in the spray dispenser wherein the composition comprises:
i) from about 5% to about 15% by weight of the composition of a surfactant system wherein the surfactant system comprises an anionic surfactant and at least one further surfactant, wherein the anionic surfactant comprises an alkyl sulfosuccinate; and
ii) from about 0.1% to about 15% by weight of the composition of an ester selected from the group consisting of :
a) monoesters having the formula R1C═OOR2 wherein:
R1 is a linear or branched C1 to C4 alkyl; and
R2 is a linear or branched C2 to C8 alkyl;
b) di- or tri-esters having the formula R1(C═OOR2)n wherein:
R1 is a saturated or unsaturated C2 to C4 alkyl;
R2 is independently selected from a linear or branched C2 to C8 alkyl; and
n is 2 or 3;
c) benzylbenzoate; and
d) mixtures thereof.

18. The product according to claim 17 wherein the alkyl sulfosuccinate comprises 2-ethylhexylsulfosuccinate.

19. A cleaning product comprising a spray dispenser and a cleaning composition suitable for spraying and foaming, the composition housed in the spray dispenser wherein the composition comprises:
iii) from about 5% to about 15% by weight of the composition of a surfactant system, wherein the surfactant system comprises an anionic surfactant and at least one further surfactant, wherein the anionic surfactant comprises a branched short chain alkyl sulphate surfactant; and
iv) from about 0.1% to about 15% by weight of the composition of an ester selected from the group consisting of :
e) monoesters having the formula R1C═OOR2 wherein:
R1 is a linear or branched C1 to C4 alkyl; and
R2 is a linear or branched C2 to C8 alkyl;
f) di- or tri-esters having the formula R1(C═OOR2)n wherein:
R1 is a saturated or unsaturated C2 to C4 alkyl;
R2 is independently selected from a linear or branched C2 to C8 alkyl; and
n is 2 or 3;
g) benzylbenzoate; and
h) mixtures thereof.

20. The product according to claim 19 wherein the branched short chain alkyl sulphate surfactant comprises branched hexyl sulphate.
